(19) United States
(12) Patent Application Publication
(10) Pub. No.: US 2009/0050442 A1
(43) Pub. Date: Feb. 26, 2009

(54) Coin and token transporter

(75) Inventors: Victor A. Quattrini, Merrimac, MA (US); Jack Bisson, Groveland, MA (US); Jeff Janway, Manchester, NH (US)

Correspondence Address: DOCKET CLERK, P.O. DRAWER 800889, DALLAS, TX, 75380, US

(73) Assignee: TELEQUIP CORPORATION, Salem, NH (US)

(21) Appl. No.: 11/895,092

(22) Filed: Aug. 23, 2007

(51) Int. Cl. G07F 9/00

(52) U.S. Cl. 194/342

(57) ABSTRACT

An apparatus, system and method are provided for transporting objects. A transporter includes a chamber and a carrier in the chamber. The chamber has an inlet, an outlet and an interior cross-section. The carrier substantially fills the cross-section of the chamber and is operable to move between first and second positions within the chamber. The carrier causes a plurality of objects that are inserted through the inlet when the carrier is in the first position to exit via the outlet as it moves from the first position to the second position. A delivery port may be coupled to the outlet of the chamber, such that objects exiting the chamber via the outlet enter the delivery port. A dispensing mechanism may inserts objects into the chamber via the inlet.

### TECHNICAL FIELD

The present disclosure is directed, in general, to a transporter for objects and, more specifically, to a coin and token transporter.

### BACKGROUND

A vending or gaming machine may deliver objects to a user of the machine. Such objects may be coins delivered as change, coins or tokens delivered as winnings, or tokens or other objects delivered as purchased products.

It may be desirable to deliver objects to the user of a vending or gaming machine at a delivery port in a location that is convenient for the user to retrieve the objects. However, a desired size and shape of such a machine may necessitate that the sub-systems or mechanisms of the machine be located in certain locations within the machine. Such arrangement of mechanisms may result in a dispenser of objects being located in a position where users would not find it convenient to receive objects directly from the dispenser. In such a case, it may be desirable to transport the objects from the location of the dispenser to a delivery location.

Where the dispenser is located above the delivery port, a passageway may be provided to guide the objects as the fall from the dispenser to the delivery port. However, some objects may be unsuitable for being dropped into a delivery port from more than a few inches because they are fragile or should not be jarred or shaken.

Where the dispenser is located laterally from the delivery port, a transporter such as a conveyor belt may be used to move the objects to the delivery port. Objects on a conveyor belt may become jammed, however, particularly where a large number of objects are to be delivered and problems may arise where the delivery port is located to the side of the conveyor belt, rather than at its end.

Where the dispenser is located below the delivery port, a series of cups may be attached to a conveyor belt to hold the objects and raise them to the delivery port, but where a large number of objects are to be delivered the objects may need to be divided among a plurality of cups. Furthermore, the transporter must be designed to such that the objects enter the delivery port while the cups are free to travel back to the dispenser.

It may be seen then that current solutions for transporting objects from a dispenser to a delivery port may be complex, unsuitable to the objects being transported, and costly to manufacture and maintain. There is, therefore, a need in the art for an improved transporter for coins, tokens and other objects.

### SUMMARY

This disclosure provides an apparatus and method for transporting objects.

In a first embodiment, a transporter includes a chamber and a carrier in the chamber. The chamber has an inlet, an outlet and an interior cross-section. The carrier substantially fills the cross-section of the chamber and is operable to move between first and second positions within the chamber. The carrier causes a plurality of objects that are inserted through the inlet when the carrier is in the first position to exit via the outlet as it moves from the first position to the second position.

In a second embodiment, a system includes a transporter for objects. The transporter includes a chamber and a carrier in the chamber. The chamber has an inlet, an outlet and an interior cross-section. The carrier substantially fills the cross-section of the chamber and is operable to move between first and second positions within the chamber. The carrier causes a plurality of objects that are inserted through the inlet when the carrier is in the first position to exit via the outlet as it moves from the first position to the second position. The system may include a delivery port that is coupled to the outlet of the chamber, such that objects exiting the chamber via the outlet enter the delivery port. The system may also include a dispensing mechanism that inserts objects into the chamber via the inlet.

In a third embodiment, a method of delivering objects to a user of a system. The method includes providing a chamber that has an inlet, an outlet and an interior cross-section. The method also includes providing a carrier in the chamber that substantially fills the cross-section of the chamber and is operable to move between first and second positions within the chamber. The method also includes providing a controller that is operable to cause objects inserted into the chamber through the inlet when the carrier is in the first position to exit the chamber via the outlet by moving the carrier from the first position to the second position.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware or in firmware or software executing on hardware. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 is an orthogonal and schematic view of a first transporter in accordance with this disclosure;

FIG. 2 is an orthogonal view of the transporter of FIG. 1 from the opposite direction of the view in FIG. 1;

FIG. 3 is a cut-away orthogonal view of the transporter of FIG. 1;

FIG. 4 is an orthogonal view of a second transporter in accordance with this disclosure;

FIG. 5 is an orthogonal view of a third transporter in accordance with this disclosure; and

FIG. 6 is a schematic view of a vending machine in accordance with this disclosure.

### DETAILED DESCRIPTION

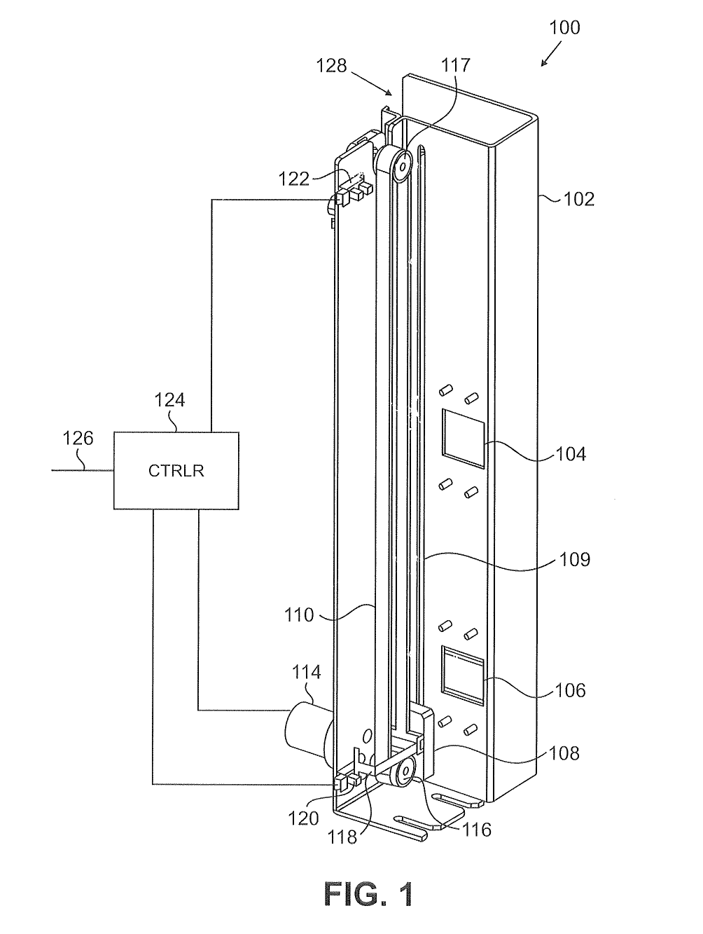

FIGS. 1 through 6, discussed below, and the various embodiments used to describe the principles of the present disclosure are by way of illustration only and should not be construed in any way to limit the scope of the invention. Those skilled in the art will understand that the principles of the present invention may be implemented in any suitably arranged device.

Although the present disclosure has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

FIGS. 1-3 present views of a first transporter 100 in accordance with this disclosure. FIG. 1 is an orthogonal view of the transporter 100, which includes a chamber 102 that has inlets 104 and 106 and an outlet 128. Objects may be inserted into the chamber 102 via the inlets 104 and 106 and transported by a carrier 130 (not shown in FIG. 1) to the outlet 128.

A link 108 is mechanically coupled to the carrier 130 through a slot 107 in a wall of the chamber 102. The link 108 is also mechanically coupled to a belt 110. The belt 110 extends around pulleys 116 and 117. The pulley 116 is mechanically coupled to a rotating shaft of a motor 114. The motor 114 rotates the pulley 116, which moves the belt 110. As the belt 110 moves, it moves the link 108 from first position at a first end of the slot 109 to a second position at a second end of the slot 109, thereby moving the carrier 130 from a first position at a first end of the chamber 102 to a second position at a second end of the chamber 102.

An extension 118 projects from the link 108. In the first position of the link 108 and the carrier 130, as shown in FIG. 1, the extension 118 breaks the beam of an optical sensor 120. When the motor 114 operates to move the link 108 and the carrier 130 away from the first position and toward the second position, the extension 118 moves out of the sensor 120 and ceases to break the beam. When the link 108 and the carrier 130 reach the second position (not shown in FIG. 10, the extension 118 breaks the beam in an optical sensor 122.

A controller 124 may be communicatively coupled to the motor 114 and the sensors 120 and 122 to control the operation of the transporter 100. The controller 124 may have an input 126 on which the controller 124 receives signals indicating a desired position for the carrier 130. The controller may respond to the signals by operating the motor 114 to move the carrier 130 to the desired position. Where the desired position is the first or second position of the carrier 130, the controller may read the status of the sensors 120 and 122 and operate the motor 114 according to the status to ensure that the carrier reaches the desired first or second position.

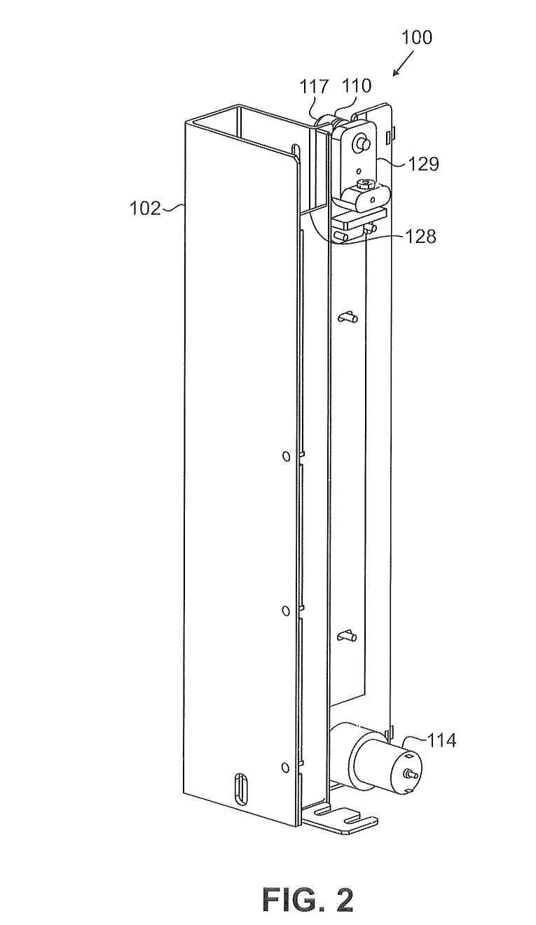

FIG. 2 is an orthogonal view of the transporter 100 from the opposite direction of the view in FIG. 1. The motor 114 and the outlet 128 may be more clearly seen in FIG. 2. Also visible in FIG. 2 is a mounting apparatus 129 to which the pulley 117 is rotatably coupled. An adjustment screw in the mounting apparatus 129 permits the axle of the pulley 117 to be moved in order to adjust the tension in the belt 110.

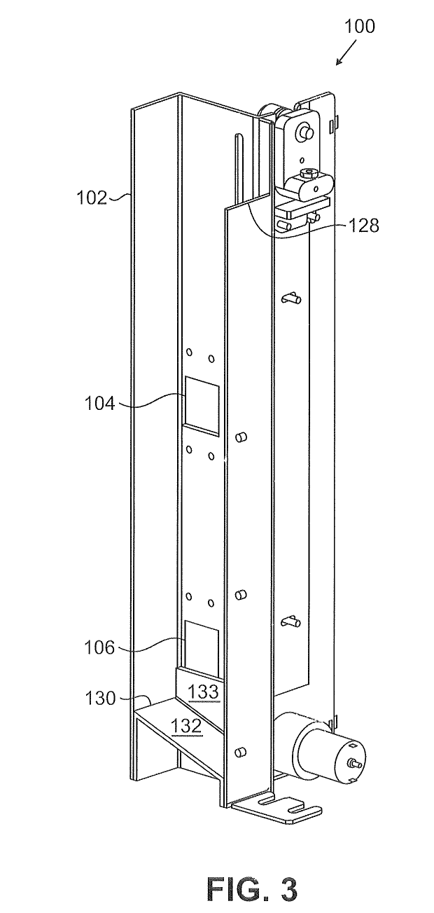

FIG. 3 is a cut-away orthogonal view of the transporter of FIGS. 1 and 2 from the same point of view as FIG. 2. A sidewall of the chamber 102 has been removed in FIG. 3 to reveal the carrier 130 that substantially fills the interior cross-section of the chamber 102. The carrier 130 has a sloped face 132 onto which objects inserted into the chamber 102 through the inlets 104 and 106 fall when the carrier is in the first position, as shown in FIG. 3. When the carrier 130 is subsequently moved to the second position, at the top of the chamber 102, the carrier 130 transports the inserted objects. In the second position, the lower edge of the sloped face 132 is substantially level with the lower edge of the outlet 128 and objects resting on the carrier 130 slide down the sloped face 132 and out of the chamber 102 via the outlet 128 under the force of gravity. The carrier 130 may then be moved back to the first position in preparation for the insertion of more objects into the chamber.

An extension 133 may extend from the sloped face 132 along the wall of the chamber 102 in which the inlets 104 and 106 are formed. As the carrier 130 is moved up the chamber 102, the extension 133 blocks the inlets 104 and 106 and prevents objects on the sloped face 132 from exiting the chamber 102 as the carrier 130 moves past the inlets 104 and 106.

While the transporter 100 is shown having two inlets, it will be understood that in other embodiments of the disclosure any number of inlets may be provided. Where the outlet is above the one or more inlets, it will be understood that in other embodiments the one or more inlets may be located in any side of the transporter chamber other than the side in which the outlet is located. While the transporter 100 is shown having two inlets located on the same side of the chamber 102, it will be understood that in other embodiments inlets may be located on more than one side of the transporter chamber.

While the outlet 128 in the transporter 100 is located above the inlets 104 and 106, and the first position of the carrier 130 is described as lower than the second position, it will be understood that in other embodiments of the disclosure those positions may be reversed. After insertion of objects into the chamber via one or more inlets, the carrier may be lowered from the first position to the second position where the objects may exit the chamber via the outlet.

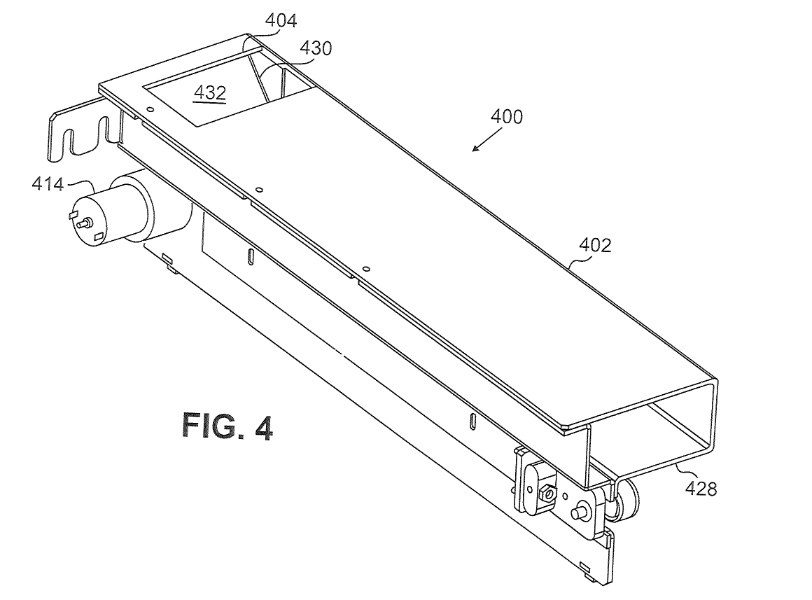

FIG. 4 is an orthogonal view of a second transporter 400 in accordance with this disclosure. The transporter 400 operates to move objects horizontally through a chamber 402 to an outlet 428. With a carrier 430 in a first position, as shown in FIG. 4, objects may be inserted into the chamber 402 through the inlet 404. Objects inserted into the chamber 402 fall upon the sloped face 432 of the carrier 430 and may slide down the sloped face 432 to lie on the bottom side of the chamber 402. A motor 414 may then operate to move the carrier 430 from the first position to a second position in the chamber 402 adjacent to the outlet 428. As the carrier moves, it pushes any objects ahead of it along the bottom side of the chamber 402 until it pushes the objects out of the chamber 402 through the outlet 428. Objects still on the sloped face 432 of the carrier 430 may slide down the sloped face 432 and out of the chamber 402 through the outlet 428 under the force of gravity.

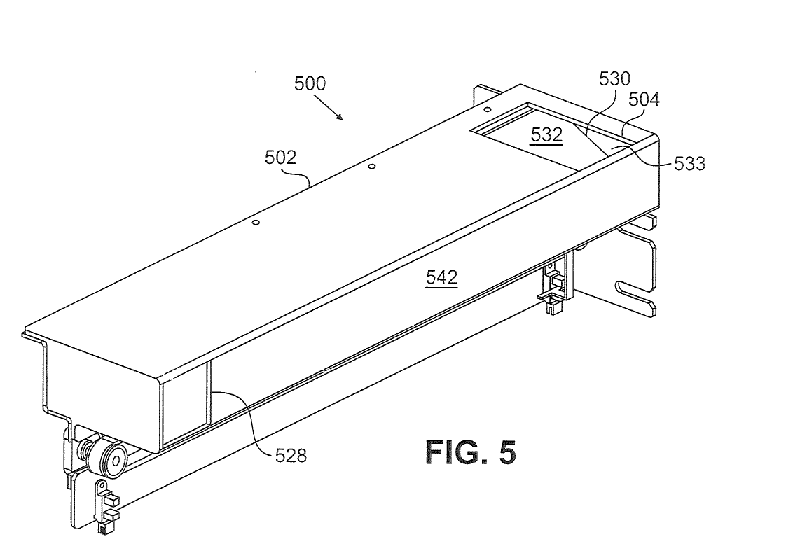

FIG. 5 is an orthogonal view of a third transporter 500 in accordance with this disclosure. The transporter 500 operates to move objects horizontally through a chamber 502 to an outlet 528. With a carrier 530 in a first position, as shown in FIG. 5, objects may be inserted into the chamber 502 through the inlet 504. Objects inserted into the chamber 502 fall upon the sloped face 532 of the carrier 530 and may slide down the sloped face 532 to rest against the side wall 542 of the chamber 502.

A motor 514 (not shown in FIG. 5) may then operate to move the carrier 530 from the first position to a second position in the chamber 502 adjacent to the outlet 528. As the carrier moves, objects are constrained to remain on the sloped face 532 by the side wall 542, a first extension 533 from one edge of the sloped face 532 and a matching second extension (not shown in FIG. 5) from the opposite edge of the sloped face 532. When the carrier 530 reaches the second position adjacent to the outlet 528, inserted objects are free to slide down the sloped face 532 and out of the chamber 502 via the outlet 528 under the force of gravity.

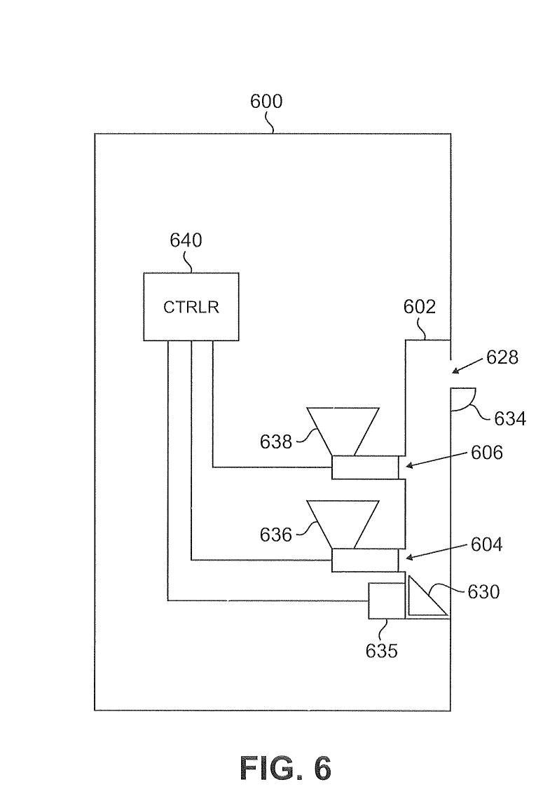

FIG. 6 is a schematic view of a vending machine 600 in accordance with this disclosure. The vending machine 600 includes a transporter 602 similar to the transporter 100 of FIGS. 1-3. The transporter 602 includes inlets 604 and 606 and an outlet 628. One difference in the transporter 602 is that the inlets 604 and 606 are in a side of the transporter 602 that is opposite to the side where the outlet 628 is located. A carrier 630 may be moved within the transporter 602 by an actuator mechanism 635, which may include a motor and sensors, as described for the transporter 100.

The carrier 630 may operate to raise objects inserted into the transporter 602 via the inlets 604 and 606 to the outlet 628. Objects exiting the transporter 602 via the outlet 628 under the force of gravity may fall into a delivery port 634 where they may be retrieved by a user of the vending machine 600.

When the carrier 630 is in a first position, as shown in FIG. 6, objects may be inserted into the transporter 602 through the inlets 604 and 606 by delivery mechanisms 636 and 638, respectively. The delivery mechanism 636 may contain objects of a first type and insert the objects into the transporter 602 upon receipt of a first signal at a control input specifying a number of objects to deliver. Similarly, the delivery mechanism 638 may insert a specified number of objects of a second type into the transporter 602 upon receipt of a second signal.

The vending machine 600 may include a controller 640 that is communicatively coupled to the actuator mechanism 635 and the delivery mechanisms 636 and 638. After ensuring that the carrier 630 is at the first position, the controller 640 may send signals to one or both of the delivery mechanisms 636 and 638 to insert objects into the transporter 602. Once insertion of the objects is complete, the controller 640 may operate the actuator mechanism 635 to move the carrier 630 to the second position, thereby delivering the objects to the delivery port 634 for retrieval by a user of the vending machine 600.

The objects contained by the delivery mechanisms 636 and 638 may comprise coins of first and second denominations, respectively, and the controller 640 may operate to dispense change to a user of the vending machine 600. In another embodiment of the disclosure, the delivery mechanisms 636 and 638 may contain coins and tokens, respectively, and the controller 640 may operate to deliver purchased tokens and coin change in a single operation or in separate operations of the transporter 602. In still other embodiments, the delivery mechanisms 636 and 638 may contain products of first and second types, respectively, for purchase and the controller 640 may operate to dispense a desired number of products upon selection by a user of the vending machine 600.

It should be understood that the above description is only illustrative of the invention. Various alternatives and modifications may be devised by those skilled in the art without departing from the disclosure. Accordingly, the present disclosure is intended to embrace all such alternatives, modifications and variances that fall with the scope of the appended claims.

What is claimed is:

1. A transporter, comprising:
a chamber having an inlet, an outlet and an interior cross-section; and
a carrier in the chamber substantially filling the interior cross-section of the chamber, the carrier operable to move between first and second positions in the chamber,
wherein the carrier is operable to cause a plurality of objects inserted into the chamber through the inlet when the carrier is in the first position to exit the chamber via the outlet when the carrier moves from the first position to the second position.

2. The transporter of claim 1, wherein a first side of the carrier has a slope and in the second position at least one of the plurality of objects slides down the slope and out of the chamber via the outlet.

3. The transporter of claim 1, wherein the chamber comprises a second inlet and the carrier is operable to cause objects inserted into the chamber through both the first and second to exit the chamber via the outlet.

4. The transporter of claim 1, wherein the carrier further comprises an extension from a first side of the carrier, the extension operating to prevent any of the plurality of objects from exiting the chamber via the inlet as the carrier moves from the first position to the second position.

5. The transporter of claim 1, wherein the inlet is located in a first side of the chamber and the outlet is located in a second side of the chamber.

6. The transporter of claim 1, wherein the carrier lifts the plurality of objects to the outlet.

7. The transporter of claim 1, wherein at least one of the plurality of objects lies on an interior side of the chamber and a first side of the carrier pushes the at least one object along the interior side of the chamber.

8. The transporter of claim 1, further comprising a controller having an input, wherein the controller is operable to cause the carrier to move from the first position to the second position in response to receiving a signal at the input.

9. The transporter of claim 8, wherein the controller further comprises a motor and first and second sensors, wherein:
the first sensor is operable to sense the carrier in the first position;
the second sensor is operable to sense the carrier in the second position; and
the motor is operable to move the carrier between the first and second positions.

10. A system, including a transporter for objects, the transporter comprising:
a chamber having an inlet, an outlet and an interior cross-section;
a carrier in the chamber substantially filling the interior cross-section of the chamber, the carrier operable to move between first and second positions in the chamber,
wherein the carrier is operable to cause a plurality of objects inserted into the chamber through the inlet when the carrier is in the first position to exit the chamber via the outlet when the carrier moves from the first position to the second position.

11. The system of claim 10, further comprising a delivery port coupled to the outlet, wherein objects exiting the chamber via the outlet enter the delivery port.

12. The system of claim 11, wherein objects in the delivery port are accessible for retrieval by a user of the vending machine.

13. The system of claim 12, wherein the objects are at least one of tokens and coins.

14. The system of claim 10, further comprising a dispensing mechanism operable to insert objects into the chamber via the inlet.

15. The system of claim 14, wherein:
the inlet comprises first and second inlets;
the dispensing mechanism comprises first and second dispensing mechanisms, coupled to the first and second inlets, respectively; and
the carrier is operable to cause objects inserted into the chamber through both the first and second inlets to exit the chamber via the outlet.

16. The system of claim 14, further comprising a controller operable to:
cause the dispensing mechanism to insert objects into the chamber only when the carrier is in the first position; and
cause the carrier to move from the first position to the second position.

17. The system of claim 10, wherein the carrier lifts the plurality of objects to the outlet.

18. The system of claim 10, wherein the system is one of a vending machine and a gaming machine.

19. A method of delivering objects to a user of a system, comprising:
providing a chamber having an inlet, an outlet and an interior cross-section;
providing a carrier in the chamber substantially filling the interior cross-section of the chamber, the carrier operable to move between first and second positions in the chamber; and
providing a controller,
wherein the controller is operable to cause objects inserted into the chamber through the inlet when the carrier is in the first position to exit the chamber via the outlet by moving the carrier from the first position to the second position.

20. The method of claim 18, further comprising providing a delivery port coupled to the outlet,
wherein objects exiting the chamber via the outlet enter the delivery port for retrieval by a user of the system.

21. The method of claim 18, further comprising dispensing objects into the inlet.
